(19) United States
(12) Patent Application Publication
(10) Pub. No.: US 2022/0186844 A1
(43) Pub. Date: Jun. 16, 2022

(54) DIAPHRAGM AND DIAPHRAGM VALVE

(71) Applicant: FUJIKIN INCORPORATED, Osaka-shi (JP)

(72) Inventors: Shunji Obara, Osaka-shi (JP); Keigo Kobayashi, Osaka-shi (JP); Keisuke Ishibashi, Osaka-shi (JP); Souta Hachiman, Osaka-shi (JP); Yusei Horikawa, Osaka-shi (JP); Taichi Kitano, Osaka-shi (JP); Kazutaka Masuda, Osaka-shi (JP)

(73) Assignee: FUJIKIN INCORPORATED, Osaka-shi (JP)

(21) Appl. No.: 17/598,444

(22) PCT Filed: Mar. 25, 2020
(86) PCT No.: PCT/JP2020/013342

§ 371 Date: Sep. 27, 2021

(30) Foreign Application Priority Data
Mar. 29, 2019 (JP) 2019-065462

(51) Int. Cl. F16K 7/12; F16K 27/02

(52) U.S. Cl. CPC F16K 7/126; F16K 27/0236

(57) ABSTRACT

To provide a diaphragm and a diaphragm valve which solve a problem of deterioration of air-tightness due to insufficient tightening of a bolt and damage to the diaphragm due to over-tightening of the bolt, as well as reducing variations in performance such as durability of the diaphragm and simplifying tightening work. A diaphragm is provided with a through hole having a diameter larger than a diameter through which a bolt can be fitly inserted. A bolt insertion cylinder made of metal through which the bolt can be inserted is fitted in the through hole. A height of the bolt insertion cylinder is equal to or less than a height of the through hole.

### TECHNICAL FIELD

The present invention relates to a diaphragm used in a diaphragm valve and the diaphragm valve.

### BACKGROUND ART

As a valve widely used in a production process of biotechnology, pharmaceuticals, and the like, there is known a diaphragm valve which opens or closes a fluid passage by providing a valve seat in a fluid passage and deforming a diaphragm to bring the diaphragm into contact with or separate it from the valve seat (Patent Literature 1).

The diaphragm used in such a valve is usually made of resin or rubber, inserted between a body and a bonnet, and fixed to the body and the bonnet with a bolt.

### CITATION LIST

### Patent Literature

PTL 1: Japanese Unexamined Patent Publication JP-A 2013-249868

### SUMMARY OF INVENTION

### Technical Problem

In the diaphragm valve of the related art, regulation (for example, tightening with a predetermined torque value) for fixing the diaphragm with a bolt is set. However, there is a problem that the regulation may not be observed and this may damage the diaphragm due to over-tightening of the bolt.

An object of the invention is to provide a diaphragm and a diaphragm valve which solve a problem of deterioration of air-tightness due to insufficient tightening of a bolt and damage to the diaphragm due to over-tightening of the bolt, as well as reducing variations in performance such as durability of the diaphragm and simplifying tightening work.

### Solution to Problem

A diaphragm according to the invention is a diaphragm for a diaphragm valve which is pinched between a body and a bonnet and fixed to the body and the bonnet with a bolt, where a through hole through which the bolt is inserted is provided and a bolt insertion cylinder made of metal through which the bolt can be inserted is fitted into the through hole, and a height of the bolt insertion cylinder is set to be smaller than a height of the through hole.

A diaphragm valve according to the invention is a diaphragm valve which includes a body with a fluid passage, a diaphragm which opens or closes the fluid passage by coming into contact with or being separated from a valve seat formed in the fluid passage, a bonnet which holds a peripheral edge portion of the diaphragm between the body and the bonnet, a stem connected to the diaphragm via a hanging metal fitting, and an operation mechanism for raising or lowering the stem and where the diaphragm is fixed to the body and the bonnet with a bolt, where in the diaphragm, a through hole through which the bolt is inserted is provided and a bolt insertion cylinder made of metal through which the bolt can be inserted is fitted into the through hole, and a height of the bolt insertion cylinder is set to be smaller than a height of the through hole.

A material of the diaphragm is not particularly limited, but rubber materials such as natural rubber, nitrile rubber, styrene rubber, fluororubber (FPM), ethylene propylene rubber (EPDM), and silicone rubber are preferably used. The diaphragm may have a single-layer structure made of the rubber material described above, or may have a two-layer structure in which a rubber layer made of the rubber material described above and a synthetic resin layer such as polytetrafluoroethylene resin (PTFE) are laminated.

Since the height of the bolt insertion cylinder is set to be smaller than the height (=the thickness of the diaphragm of a portion where the through hole is provided) of the through hole, only the diaphragm is compressed first when the bolt is tightened to fix the diaphragm. Then, by further tightening the bolt, the bolt insertion cylinder is pinched between the body and the bonnet. In this case, since the bolt insertion cylinder is made of metal, further tightening becomes difficult. A difference between the height of the bolt insertion cylinder and the height of the through hole is set so that this state becomes a proper tightening state. Therefore, by tightening the bolt until tightening becomes difficult, proper tightening is possible without using a torque wrench, and thus the tightening work is simplified. Further, by eliminating over-tightening, the diaphragm is prevented from being damaged, and by performing uniform tightening, it is also possible to prevent the performance of the diaphragm from deteriorating due to insufficient tightening.

The bolt insertion cylinder may be made of metal and integrated with the diaphragm by molding. The bolt insertion cylinder may be inserted into the through hole after the diaphragm is molded (vulcanized) by the same method of the related art, or the vulcanization (molding) may be performed after the bolt insertion cylinder is first fitted into the diaphragm before vulcanization, and the latter is more preferable.

The diaphragm valve may be called a weir type in which a weir which receives the diaphragm is provided in the fluid passage, or may be called a wireless type in which a weir which receives the diaphragm is not provided in the fluid passage.

It is preferable that at least one recess or convex portion be provided on an outer circumference of the bolt insertion cylinder of the diaphragm.

Fitting between the through hole and the bolt insertion cylinder may be clearance fitting in terms of preventing damage to the diaphragm. However, from the viewpoint of ease of handling, the fitting of the through hole and the bolt insertion cylinder is preferably fitting that can prevent the bolt insertion cylinder from falling off. By providing at least one recess or convex portion on the outer circumference of the bolt insertion cylinder of the diaphragm, it is possible to more reliably prevent the bolt insertion cylinder from falling off.

### Advantageous Effects of Invention

According to the diaphragm for a diaphragm valve and the diaphragm valve of the invention, proper tightening is possible without using a torque wrench, and thus the tightening work is simplified. Further, by eliminating over-tightening, the diaphragm is prevented from being damaged, and by performing uniform tightening, it is also possible to prevent the performance of the diaphragm from deteriorating due to insufficient tightening.

### BRIEF DESCRIPTION OF DRAWINGS

FIG. 1 is a vertical cross-sectional view illustrating an overall configuration of a first embodiment of a diaphragm for a diaphragm valve and the diaphragm valve according to the invention.

FIG. 2 is a side view of FIG. 1.

FIG. 3 is a plan view of the diaphragm.

FIG. 4A is a partial cross-sectional view taken along the line X-X of FIG. 3 and FIG. 4B is an enlarged cross-sectional view illustrating a height relationship between a through hole and a bolt insertion cylinder.

FIG. 5 is an exploded perspective view of the diaphragm.

FIGS. 6A and 6B are views illustrating an embodiment of the bolt insertion cylinder, where FIG. 6A is a perspective view and FIG. 6B is a front view.

FIGS. 7A and 7B are views illustrating another embodiment of the bolt insertion cylinder, where FIG. 7A is a perspective view and FIG. 7B is a front view.

FIGS. 8A and 8B are views illustrating still another embodiment of the bolt insertion cylinder required to be realized by molding processing such as vulcanization molding, where FIG. 8A is a perspective view and FIG. 8B is a front view.

FIG. 9 is a vertical cross-sectional view illustrating an overall configuration of a second embodiment of a diaphragm for a diaphragm valve and the diaphragm valve according to the invention.

FIG. 10 is a front cross-sectional view illustrating another embodiment of the diaphragm.

FIG. 11 is a cross-sectional view taken along a diagonal line of the diaphragm illustrated in FIG. 10, which corresponds to FIG. 4A.

### DESCRIPTION OF EMBODIMENTS

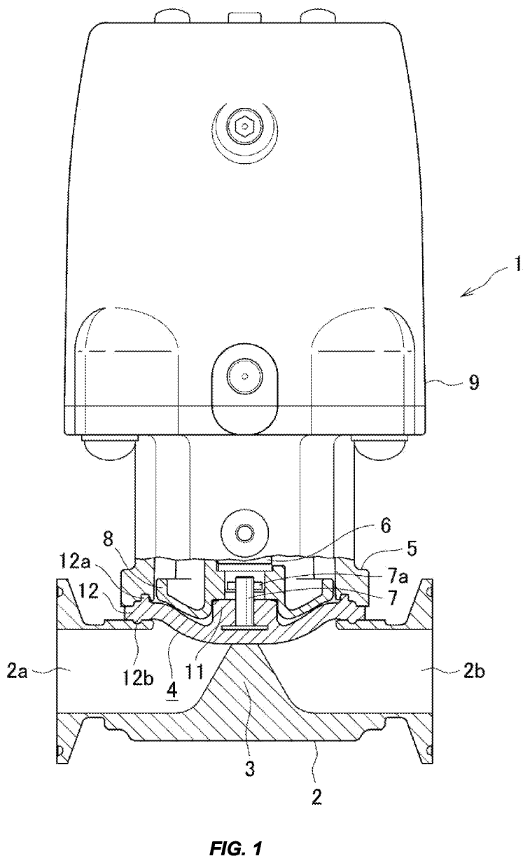

A first embodiment of a diaphragm for a diaphragm valve and the diaphragm valve of the invention is illustrated in FIGS. 1 to 5. In the following description, up/down and left/right refer to up/down and left/right in FIG. 1. The up/down and left/right are for convenience, and when installed, the up/down may be upside down or horizontal.

A diaphragm valve 1 is weir-type and automatic. As illustrated in FIG. 1, the diaphragm valve 1 includes a body 2 having a fluid inflow passage 2a and a fluid outflow passage 2b extending to the left and right, a weir 3 as a valve seat provided between the fluid inflow passage 2a and the fluid outflow passage 2b of the body 2, a diaphragm 4 which opens and closes between the fluid inflow passage 2a and the fluid outflow passage 2b by coming into contact with and being separated from an upper surface of the weir 3, a bonnet 5 which holds a peripheral edge portion of the diaphragm 4 between the body 2 and the bonnet 5, a stem 6 connected to the diaphragm 4 via a hanging metal fitting 7, a diaphragm retainer 8 fixed to a lower end portion of the stem 6, and an operation mechanism 9 which moves the stem 6 up and down to move the diaphragm 4 in an open or closed direction.

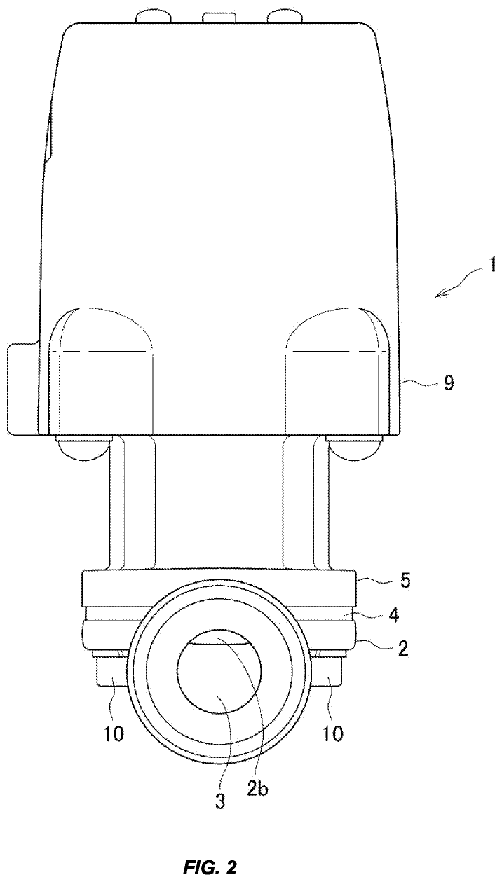

The diaphragm 4 has a single-layer structure made of a rubber material, a resin, and an elastomer. The diaphragm has a rectangular shape when viewed from above, is inserted between the body 2 and the bonnet 5, and is fixed to the body 2 and the bonnet 5 with a bolt 10, as illustrated in FIG. 2. The hanging metal fitting 7 is provided with a hook 7a which is inserted into the stem 6 to prevent it from coming off.

Although not illustrated, the operation mechanism 9 may, for example, move a piston fixed to the stem 6 up and down by compressed air against an urging force of a compression coil spring, or may simply move it up and down by compressed air.

At a center of the diaphragm 4, a columnar protruding portion 11 protruding upward is provided. A lower part of the hanging metal fitting 7 connected to the stem 6 is embedded in the protruding portion 11. Further, on a peripheral edge of the diaphragm 4, a circular pinched portion 12 is provided so as to be concentric with the protruding portion 11. The pinched portion 12 is a portion pinched between the body 2 and the bonnet 5. A protrusion 12a which fits into a recess provided on a lower surface of the bonnet 5 is provided on an upper surface of the pinched portion 12 and a protrusion 12b which fits into a recess provided on an upper surface of the body 2 is provided on a lower surface of the pinched portion 12.

When the stem 6 is lowered by the operation mechanism 9, a central portion of the diaphragm 4 is moved downward by the hanging metal fitting 7 and the diaphragm retainer 8. As a result, the central portion of the diaphragm 4 comes into contact with an upper surface of the weir 3 and a closed state illustrated in FIG. 1 is obtained.

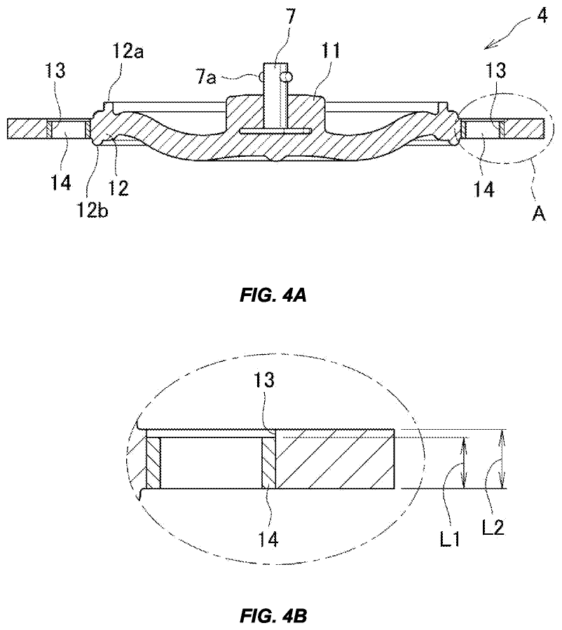

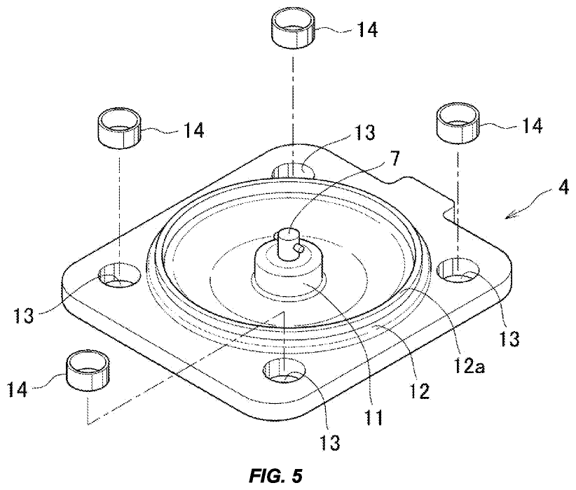

The above configuration is the same as that of the related art and, as illustrated in FIGS. 4A, 4B, and 5, the diaphragm valve 1 of this embodiment is different from that of the related art in that the diaphragm 4 has a configuration in which metal bolt insertion cylinders 14 are fitted into through holes 13 provided at four corners of a square portion.

The through hole 13 has a circular cross section and has a diameter larger than a diameter through which the bolt insertion cylinder can be fitly inserted. The bolt insertion cylinder 14 is a short cylinder and its inner diameter is set to a size which allows the bolt 10 to be inserted fitly.

Further, a height L1 of the metal bolt insertion cylinder 14 is the same as or smaller than a height L2 (=the thickness of the diaphragm 4 of a portion where the through hole 13 is provided) of the through hole 13. Further, a difference between the height of the bolt insertion cylinder 14 and the height (that is, the thickness of the diaphragm 4 of the portion where the through hole 13 is provided) of the through hole 13 is set such that, when the bolt 10 is tightened, a state in which the bolt insertion cylinder 14 is pinched between the body 2 and the bonnet 5 becomes a proper tightening state.

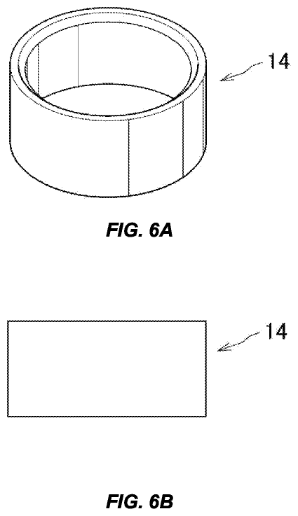

An outer peripheral surface of the bolt insertion cylinder 14 has an appropriate shape suitable for fitting into the through hole 13. An example thereof is illustrated in FIGS. 6A to 8B.

In FIG. 6, the outer peripheral surface of the bolt insertion cylinder 14 is a cylindrical surface. Here, the cylindrical surface may be a completely smooth cylindrical surface, but it is more preferable that the cylindrical surface is processed to increase a friction coefficient by knurling, satin finish, or the like.

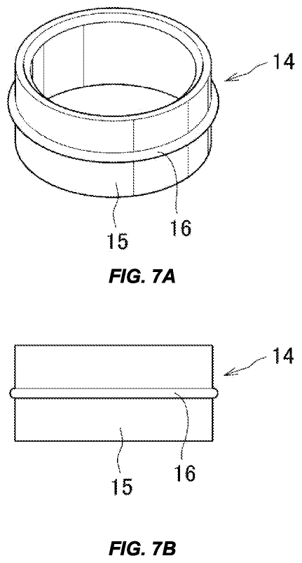

In FIGS. 7A and 7B, the bolt insertion cylinder 14 is assumed to be provided with an annular convex portion 16 on an outer peripheral surface of a central portion of a cylindrical body 15 in an axial direction. For example, by making an outer diameter of the cylindrical body 15 slightly smaller than an inner diameter of the through hole 13 and making an outer diameter of the annular convex portion 16 slightly larger than the inner diameter of the through hole 13, it is possible to provide the bolt insertion cylinder which is easy to insert when it is inserted into the diaphragm 4 after molding and is difficult to fall off or come off.

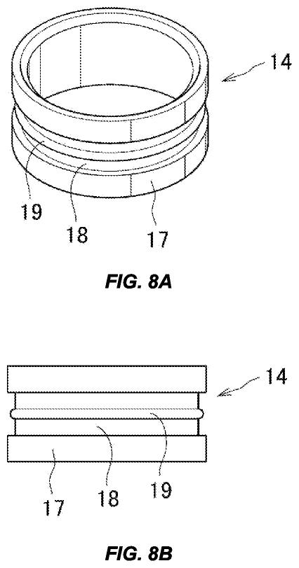

In FIGS. 8A and 8B, the bolt insertion cylinder 14 is assumed to have an annular recess 18 provided on the outer peripheral surface of the axially central portion of a cylindrical body 17 and an annular convex portion 19 provided on an axially central portion of the recess 18. In this embodiment, by inserting the bolt insertion cylinder 14 into the diaphragm before vulcanization first, rubber flows into the recess 18 during vulcanization and this makes it difficult for the bolt insertion cylinder 14 to fall off or come off.

According to the diaphragm 4 described above, since the height of the bolt insertion cylinder 14 is set to be smaller than the height (=the thickness of the diaphragm 4 of the portion where the through hole 13 is provided) of the through hole 13, only the diaphragm 4 is compressed first when the bolt 10 is tightened to fix the diaphragm 4. Then, by further tightening the bolt 10, the bolt insertion cylinder 14 is pinched between the body 2 and the bonnet 5. In this case, since the bolt insertion cylinder 14 is made of metal, further tightening becomes difficult. This corresponds to a proper tightening state, and by tightening until tightening becomes difficult, proper tightening is possible without using a torque wrench.

Therefore, according to the diaphragm 4 described above, the tightening work is simplified. Moreover, by eliminating over-tightening, the diaphragm is prevented from being damaged, and by performing uniform tightening, variations are reduced. As a result, external leakage due to insufficient tightening and deterioration of the durability performance of the diaphragm are also prevented.

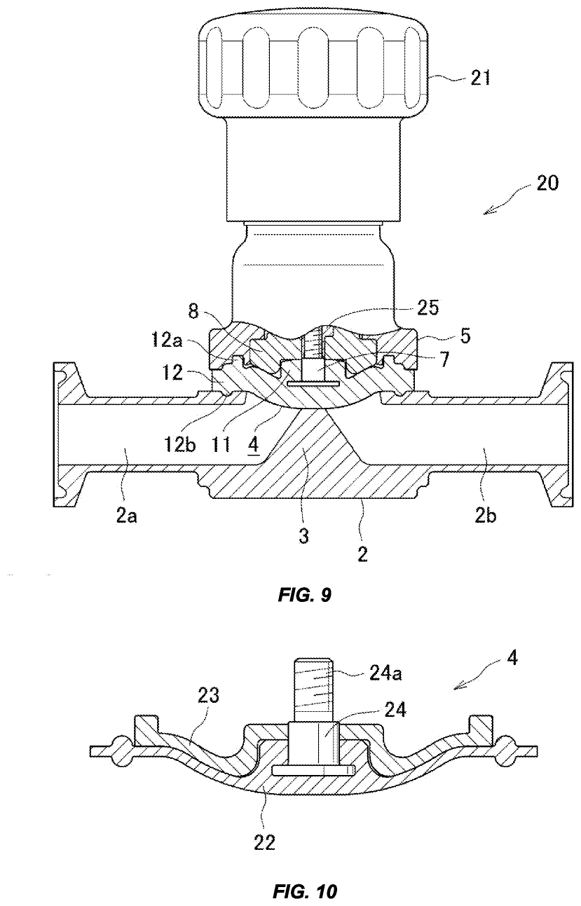

Although FIGS. 1 and 2 illustrate the automatic diaphragm valve 1 using compressed air, as illustrated in FIG. 9, the diaphragm 4 described above can also be applied to a manual diaphragm valve 20 which moves the stem 6 up and down by manually rotating a handle 21. In FIG. 9, parts having the same functions as those in FIG. 1 are designated by the same reference numerals as those in FIG. 1 and the description thereof will be omitted.

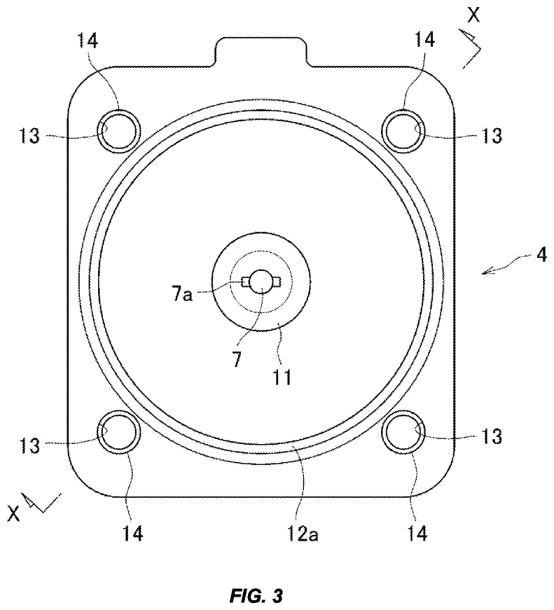

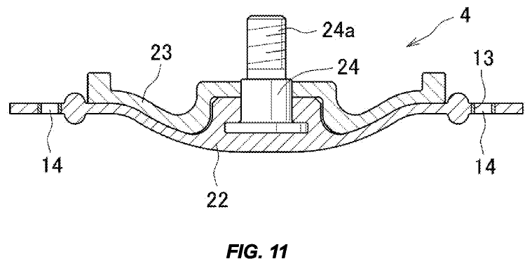

Further, FIG. 3 illustrates the diaphragm 4 having a single-layer structure made of a rubber material, a resin, and an elastomer. However, in the diaphragm 4 illustrated in FIG. 9, a two-layer structure of a diaphragm subjected to a laminate process with a resin attached to a side in contact with the weir 3 may be used. Further, as illustrated in FIG. 10, the diaphragm 4 may have a two-layer structure consisting of a resin layer (for example, made of PTFE) 22 on a side in contact with the weir 3 and a rubber layer 23 on a side in contact with the diaphragm retainer 8. In this case, in a type illustrated in FIG. 9, it becomes a part up to the laminate including the rubber material, the resin, and the elastomer part. Also, in a type of FIG. 10, as illustrated in FIG. 11, the through hole 13 into which the bolt insertion cylinder 14 is fitted is provided in the resin layer 22. In FIG. 10, a male screw portion 24a which can be screwed to a female screw portion provided on a sleeve 25 is provided on an upper portion of a hanging metal fitting 24 instead of the hook.

Although not illustrated, various structures of the related art can be used for the diaphragm configuration and the diaphragm valve configuration.

### INDUSTRIAL APPLICABILITY

According to the invention, it is possible to contribute to the performance improvement of the diaphragm for the diaphragm valve and the diaphragm valve widely used in the production process of semiconductors, biotechnology, pharmaceuticals, and the like.

### REFERENCE SIGNS LIST

1 diaphragm valve
2 body
2a fluid inflow passage (fluid passage)
2b fluid outflow passage (fluid passage)
4 diaphragm
5 bonnet
6 stem
7 hanging metal fitting
9 operation mechanism
10 bolt
13 through hole
14 bolt insertion cylinder
16 convex portion
18 recess
19 convex portion
20 diaphragm valve

1. A diaphragm for a diaphragm valve which is pinched between a body and a bonnet and fixed to the body and the bonnet with a bolt, wherein
a through hole through which the bolt is inserted is provided and a bolt insertion cylinder made of metal through which the bolt can be inserted is fitted into the through hole, and a height of the bolt insertion cylinder is set to be smaller than a height of the through hole.

2. The diaphragm according to claim 1, wherein
at least one recess or convex portion is provided on an outer circumference of the bolt insertion cylinder.

3. The diaphragm according to claim 1, wherein
the bolt insertion cylinder is made of metal and is integrated with the diaphragm by molding.

4. A diaphragm valve which includes a body with a fluid passage, a diaphragm which opens or closes the fluid passage by coming into contact with or being separated from a valve seat formed in the fluid passage, a bonnet which holds a peripheral edge portion of the diaphragm between the body and the bonnet, a stem connected to the diaphragm via a hanging metal fitting, and an operation mechanism for raising or lowering the stem and where the diaphragm is fixed to the body and the bonnet with a bolt, wherein
in the diaphragm, a through hole through which the bolt is inserted is provided and a bolt insertion cylinder made of metal through which the bolt can be inserted is fitted into the through hole, and a height of the bolt insertion cylinder is set to be smaller than a height of the through hole.

5. The diaphragm valve according to claim 4, wherein
at least one recess or convex portion is provided on an outer circumference of the bolt insertion cylinder.

6. The diaphragm valve according to claim 4, wherein
the bolt insertion cylinder is made of metal and is integrated with the diaphragm by molding.

7. The diaphragm according to claim 2, wherein
the bolt insertion cylinder is made of metal and is integrated with the diaphragm by molding.

8. The diaphragm valve according to claim 5, wherein
the bolt insertion cylinder is made of metal and is integrated with the diaphragm by molding.
